(19) United States
(12) Patent Application Publication
(10) Pub. No.: US 2020/0012139 A1
(43) Pub. Date: Jan. 9, 2020

(54) PIXEL STRUCTURE, DISPLAY PANEL AND DISPLAY APPARATUS

(71) Applicants: Beijing BOE Optoelectronics Technology Co., Ltd., Beijing (CN); BOE Technology Group Co., Ltd., Beijing (CN)

(72) Inventors: Xiaoqing PENG, Beijing (CN); Kaixuan WANG, Beijing (CN); Hongliang YUAN, Beijing (CN); Li MA, Beijing (CN); Huishun CHEN, Beijing (CN)

(21) Appl. No.: 16/094,134

(22) PCT Filed: Mar. 7, 2018
(86) PCT No.: PCT/CN2018/078214

§ 371 Date: Oct. 16, 2018

(30) Foreign Application Priority Data
Mar. 29, 2017 (CN) 201710198389.9

(51) Int. Cl. G02F 1/1339; G02F 1/1335

(52) U.S. Cl. CPC G02F 1/13394; G02F 1/133512; G02F 1/133514

(57) ABSTRACT

Disclosed are a pixel structure, a display panel and a display apparatus, used for reducing the risk of poor display caused due to the fact that horizontal stripes, vertical stripes or diagonal stripes occur in a pure-colour picture, thereby improving the display quality of a product and enhancing the user experience. Provided is a pixel structure. The pixel structure comprises: different colours of sub-pixels, and photo spacers arranged in regions of the sub-pixels, wherein the photo spacers comprise main photo spacers, and the main photo spacers are arranged in regions of the sub-pixels of at least two colours.

This application is a National Stage of International Application No. PCT/CN2018/078214, filed Mar. 7, 2018, which claims the priority of Chinese Patent Application No. 201710198389.9, filed with the Chinese Patent Office on Mar. 29, 2017, and entitled “Pixel structure, display panel and display device”, which is hereby incorporated by reference in its entirety.

### FIELD

The present application relates to the field of display technologies, and particularly to a pixel structure, a display panel, and a display device.

### BACKGROUND

A liquid crystal display panel includes an array substrate, a color filter substrate, and a liquid crystal layer filled between them. The array substrate is divided by data lines and gate lines of the array substrate into separate sub-pixels, each of which includes a Thin Film Transistor (TFT), a pixel electrode, etc., the Color Filter (CF) substrate includes a color filter sheet, Black Matrixes (BMs), Photo Spacer (PS), etc., and the black matrixes, the gate lines, and the data lines are positioned to define the sub-pixels. The thickness of the liquid crystal layer (i.e., a cell gap) is generally controlled as a function of the height of a PS. The PS's include primary PS and secondary PS, where the height of a primary PS is more than the height of a secondary PS, so that the primary PS supports a cell gap when no pressure is applied to the liquid crystal panel, and the liquid crystal panel has come into contact with the surface of the array substrate; and the secondary PS supports a cell gap only when an excessive tierce is applied to the liquid crystal panel.

At present, the primary PS's are generally arranged on sub-pixels in the same one color, so that the display abnormality such as a transverse line, a longitudinal line, an oblique line tends to occur in a monochromatic picture.

### SUMMARY

Embodiments of the disclosure provide a pixel structure, a display panel, and a display device in the following solutions.

An embodiment of this disclosure provides a pixel structure. The pixel structure includes a plurality of sub-pixels in different colors, and a plurality of photo spacers arranged in sub-pixel areas, wherein the photo spacers include primary photo spacers arranged in the sub-pixel areas in at least two of the colors.

Optionally the primary photo spacers are arranged in sub-pixel areas in at least two colors in equal proportion.

Optionally the sub-pixels in the different colors include sub-pixels in a first color, sub-pixels in a second color, and sub-pixels in a third color.

Optionally the primary photo spacers are arranged in sub-pixel areas in the first color, sub-pixel areas in the second color, and sub-pixel areas in the third color in equal proportion.

Optionally the primary photo spacers are arranged in sub-pixel areas in any two of the colors among sub-pixel areas in the first color, sub-pixel areas in the second color, and sub-pixel areas in the third color, in equal proportion.

Optionally the sub-pixels in the first color are red sub-pixels, the sub-pixels in the second color are green sub-pixels, and the sub-pixels in the third color are blue sub-pixels.

Optionally each of the sub-pixel areas further includes a black matrix, and a positive projection of each of the photo spacers in a direction perpendicular to the pixel structure lies within a positive projection of each black matrix in the direction perpendicular to the pixel structure.

Optionally the photo spacers further include secondary photo spacers, and in the direction perpendicular to the pixel structure, an area of a positive projection of the black matrix surrounding the primary photo spacer is larger than an area of a positive projection of the black matrix surrounding the secondary photo spacer.

Optionally the secondary photo spacers are arranged in sub-pixel areas in at least two of the colors in equal proportion.

Optionally the pixel structure further includes a color filter substrate on which the sub-pixels are located.

An embodiment of the disclosure provides a display panel including the pixel structure according to the embodiment of the disclosure.

An embodiment of the disclosure provides a display device including the display panel according to the embodiment of the disclosure.

### BRIEF DESCRIPTION OF THE DRAWINGS

FIG. 1 is a schematic structural diagram of the primary photo spacers, the secondary photo spacers, and the black matrixes in the related art;

FIG. 2 is a schematic diagram of the display abnormality including the transverse line, the longitudinal line, the oblique line resulting from arrangement of the primary photo spacers in the related art;

FIG. 3 is a schematic diagram of a pixel structure according to an embodiment of the disclosure;

FIG. 4 is a schematic diagram of another pixel structure according to an embodiment of the disclosure;

FIG. 5 is a schematic diagram of another pixel structure according to an embodiment of the disclosure; and

FIG. 6 is a schematic diagram of another pixel structure according to an embodiment of the disclosure.

### DETAILED DESCRIPTION

In a specific implementation, the material of the PS's is an elastic polymer, the PS's are formed in the areas, where the black matrixes are located, on the CF substrate, and the primary PS's support the TFTs of the array substrate after the substrates are aligned into the liquid crystal box. When an external tangent pressure is applied to the liquid crystal panel, the tops of the primary PS's tend to slide over the TFTs, thus resulting in scratching an orientation film (for example, Polyimide Film, PI), which may destroy ordered orientation of the orientation film. When the external tangent pressure is too large, the orientation film may be scratched in an opening area of a sub-pixel so that a press gap may occur in a black picture, where the press is distributed on the liquid crystal panel at the same periodicity as the primary PS's.

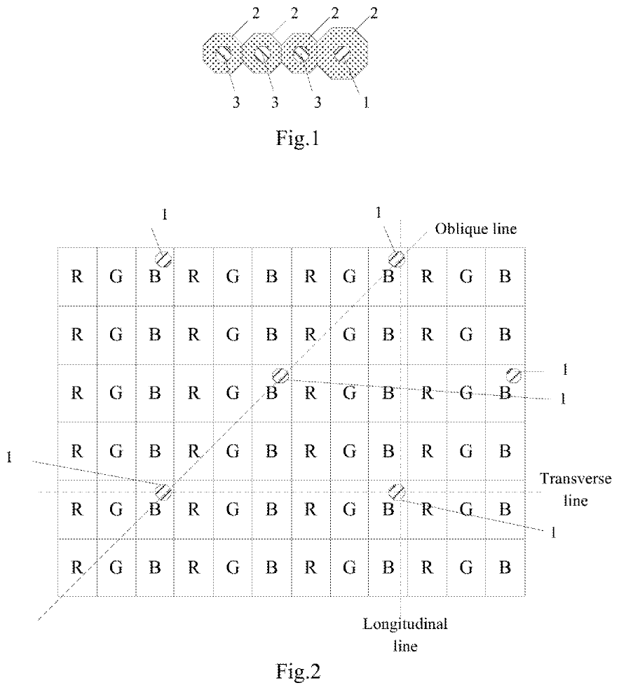

In the related art, the primary PS's are generally arranged on blue sub-pixels, and in order to shield scratching of the orientation film, and to avoid leaking of light, the width of a BM 2 surrounding a primary PS 1 is increased as illustrated in FIG. 1, that is, the width of the BM 2 surrounding the primary PS 1 is more than the width of a BM 2 surrounding a secondary PS 3. For a product with a high Pixels Per Inch (PPI), the size of a sub-pixel is small, so when the width of a BM surrounding a primary PS is increased, then there may be a significant difference between an opening ratio of a sub-pixel corresponding to a primary PS and an opening ratio of a sub-pixel corresponding to a secondary PS; and as illustrated in FIG. 2, R, and B represent red, green, and blue sub-pixel areas respectively, and when the primary PS's are arranged only in the blue sub-pixel areas, the display abnormality such as a transverse line, a longitudinal line, or an oblique line tends to occur in an all-White picture, and particularly an all-blue picture.

In view of this, the embodiments of this disclosure provides a pixel structure, a display panel, and a display device so as to lower a risk of the display abnormality, such as a transverse line, a longitudinal line, or an Oblique line, in a monochromatic picture, thus improving the display quality of the product, and improving the experience of a user thereof.

In order to make the objects, technical solutions, and advantages of the invention more apparent, the invention will be described below in further details with reference to the drawings, and apparently the embodiments to be described are only a part but not all of the embodiments of the invention. Based upon the embodiments here of the invention, all the other embodiments which can occur to those ordinarily skilled in the art without any inventive effort shall fall into the claimed scope of the invention.

The shapes and sizes of respective components in the drawings are not intended to reflect any real proportion, but only intended to illustrate the disclosure of the invention.

Specifically an embodiment of this disclosure provides a pixel structure. The pixel structure includes a plurality of sub-pixels in different colors, and a plurality of photo spacers arranged in sub-pixel areas, where the photo spacers include primary photo spacers arranged in the sub-pixel areas in at least two of the colors.

In the pixel structure according to the embodiment of this disclosure, the primary photo spacers are arranged in the sub-pixel areas in at least two colors, so that when the total number of arranged primary photo spacers is constant, the primary photo spacers will not be arranged in the sub-pixel areas in only one of the colors, which would otherwise have resulted in a too high density of the primary photo spacers in the sub-pixel areas in that color, thus lowering the density of the primary photo spacers in the sub-pixel areas in a single color, and consequently such a risk of the display abnormality such as a transverse line, a longitudinal line, or an Oblique line in a monochromatic picture. Furthermore in the pixel structure according to the embodiment of this disclosure, no new fabrication process is introduced, a good yield of the fabricated product isn't lowered, and a cost thereof isn't increased.

Optionally the sub-pixels in the different colors include sub-pixels in a first color, sub-pixels in a second color, and sub-pixels in a third color.

It shall be noted that the pixel structure can include sub-pixels in three different colors, or can include sub-pixels in four or more colors, and the colors of the sub-pixels can be selected as needed in reality. When the pixel structure includes sub-pixels in three different colors, the primary photo spacers can be arranged in sub-pixel areas in two of the colors, or can be arranged in sub-pixel areas in the three colors. In the case that the total number of arranged primary photo spacers remains constant, the primary photo spacers can be arranged in sub-pixel areas in at least two colors, that is, the primary photo spacers can be arranged in sub-pixel areas in more than one color, to thereby lower a risk of display abnormality such as a transverse line, a longitudinal line, or an oblique line in a monochromatic picture. For example, when the pixel structure includes sub-pixels in three colors, and N primary photo spacers needs to be arranged, the primary photo spacers can be arranged in sub-pixel areas in two colors in such a way that N/3 primary photo spacers are arranged in sub-pixel areas in one of the colors, and 2N/3 primary photo spacers are arranged in sub-pixel areas in the other color. Of course, the primary photo spacers can alternatively be arranged in sub-pixel areas in different colors in another proportion, although the embodiment of this disclosure will not be limited thereto.

Optionally the primary photo spacers are arranged in sub-pixel areas in at least two colors in equal proportion.

For example, the primary photo spacers are arranged in sub-pixel areas in any two colors among the sub-pixel areas in the first color, the sub-pixel areas in the second color, and the sub-pixel areas in the third color in equal proportion. When N primary photo spacers need to be arranged in the pixel structure, N/2 primary photo spacers are arranged in sub-pixel areas in each color.

Alternatively the primary photo spacers are arranged in the sub-pixel areas in the first color, the sub-pixel areas in the second color, and the sub-pixel areas in the third color in equal proportion. When the pixel structure includes sub-pixels in three colors, and N primary photo spacers needs to be arranged, N/3 primary photo spacers are arranged in sub-pixel areas in each color.

In the pixel structure according to the embodiment of the disclosure, the primary photo spacers are arranged in sub-pixel areas in different colors in equal proportion so that there is a uniform density of the primary photo spacers in the sub-pixel areas in each color, and as a result, there is a uniform display effect of a monochromatic picture in the corresponding color, thus further improving the display quality of the product, and the experience of a user thereof.

Optionally the sub-pixels in the first color are red sub-pixels, the sub-pixels in the second color are green sub-pixels, and the sub-pixels in the third color are blue sub-pixels. Of course, the sub-pixels in the first color, the sub-pixels in the second color, and the sub-pixels in the third color can alternatively be sub-pixels in other colors.

The pixel structure according to the embodiments of this disclosure will be described below by way of an example in which the pixel structure includes red sub-pixels, blue sub-pixels, and green sub-pixels, and the primary photo spacers are arranged in sub-pixel areas in different colors in equal proportion.

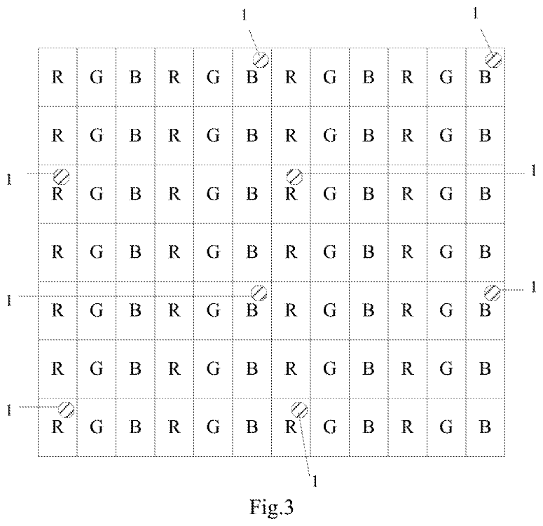

In a first embodiment, as illustrated in FIG. 3, R, G, and B represent red sub-pixel areas, green sub-pixel areas, and blue sub-pixel areas respectively, and primary photo spacers 1 are arranged in the red sub-pixel areas R and the blue sub-pixel areas B. N primary photo spacers 1 are arranged in the pixel structure in such a way that the primary photo spacers 1 are arranged in the red sub-pixel areas R and the blue sub-pixel areas B in equal proportion, that is, N/2 primary photo spacers 1 are arranged in the red sub-pixel areas R and N/2 primary photo spacers 1 are arranged in the blue sub-pixel areas B, and as compared with the primary photo spacers 1 arranged only in sub-pixel areas in one color, the density of the primary photo spacers 1 in sub-pixel areas in each color can be lowered to thereby lower a risk of display abnormality including a transverse line, a longitudinal line, or an oblique line in a monochromatic picture. Furthermore there is a uniform density of the primary photo spacers 1 in the red sub-pixel areas R and the blue sub-pixel areas B, and as a result, there is a uniform display effect of a monochromatic picture in the corresponding color, thus further improving the display quality of the product, and the experience of a user thereof.

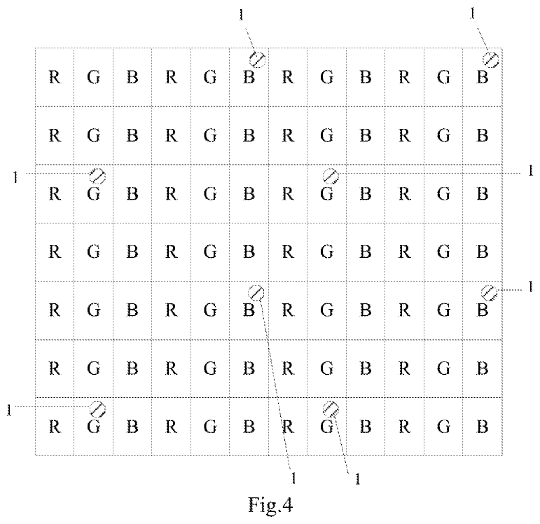

In a second embodiment, as illustrated in FIG. 4, R, and B represent red sub-pixel areas, green sub-pixel areas, and blue sub-pixel areas respectively, and primary photo spacers 1 are arranged in the blue sub-pixel areas B and the green sub-pixel areas a N primary photo spacers 1 are arranged in the pixel structure in such a way that the primary photo spacers 1 are arranged in the blue sub-pixel areas B and the green sub-pixel areas G in equal proportion, that is, N/2 primary photo spacers 1 are arranged in the blue sub-pixel areas B and N/2 primary photo spacers 1 are arranged in the green sub-pixel areas G, and as compared with the primary photo spacers 1 arranged only in sub-pixel areas in one color, the density of the primary photo spacers 1 in sub-pixel areas in each color can be lowered to thereby lower a risk of the display abnormality such as a transverse line, a longitudinal line, or an oblique line in a monochromatic picture. Furthermore there is a uniform density of the primary photo spacers 1 in the blue sub-pixel areas B and the green sub-pixel areas G. and as a result, there is a uniform display effect of a monochromatic picture in the corresponding color, thus further improving the display quality of the product, and the experience of a user thereof.

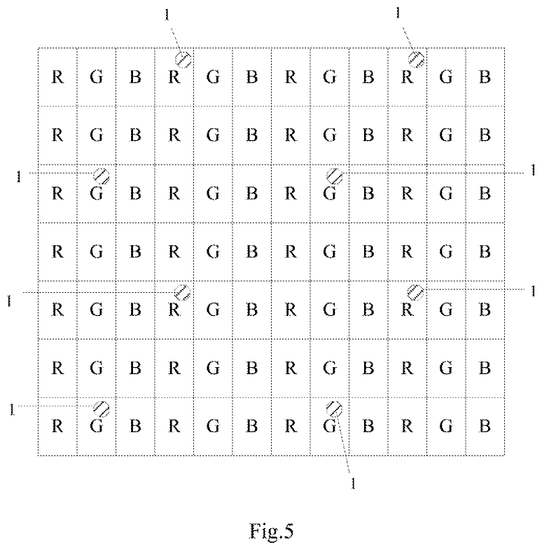

In a third embodiment, as illustrated in FIG. 5. R, G, and B represent red sub-pixel areas, green sub-pixel areas, and blue sub-pixel areas respectively, and primary photo spacers 1 are arranged in the red sub-pixel areas R and the green sub-pixel areas G. N primary photo spacers 1 are arranged in the pixel structure in such a way that the primary photo spacers 1 are arranged in the red sub-pixel areas R and the green sub-pixel areas G in equal proportion, that is, N/2 primary photo spacers 1 are arranged in the red sub-pixel areas R and N/2 primary photo spacers 1 are arranged in the green sub-pixel areas G, and as compared with the primary photo spacers 1 arranged only in sub-pixel areas in one color, the density of the primary photo spacers 1 in sub-pixel areas in each color can be lowered to thereby lower such a risk of the display abnormality such as a transverse line, a longitudinal line, or an oblique line in a monochromatic picture. Furthermore there is a uniform density of the primary photo spacers 1 in the red sub-pixel areas R and the green sub-pixel areas G, and as a result, there is a uniform display effect of a monochromatic picture in the corresponding color, thus further improving the display quality of the product, and the experience of a user thereof.

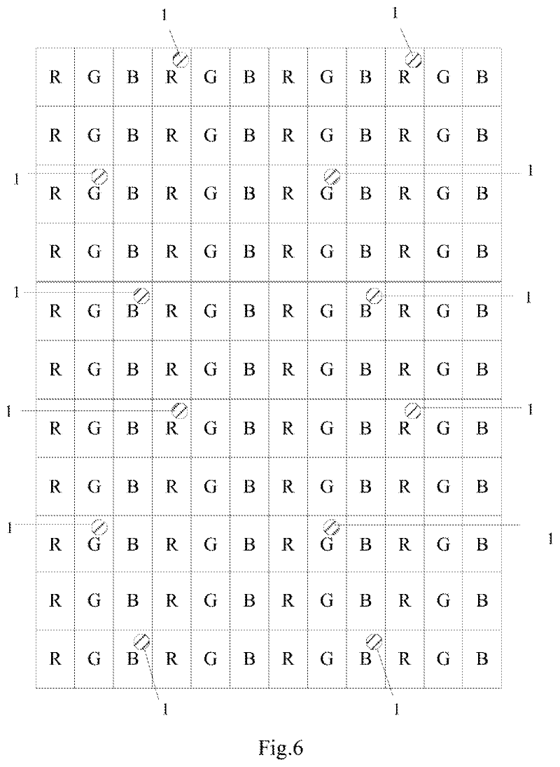

In a fourth embodiment, as illustrated in FIG. 6, R, G, and B represent red sub-pixel areas, green sub-pixel areas, and blue sub-pixel areas respectively. The primary photo spacers 1 are arranged in the red sub-pixel areas R, the blue sub-pixel areas B, and the green sub-pixel areas G. N primary photo spacers 1 are arranged in the pixel structure in such a way that the primary photo spacers 1 are arranged in the red sub-pixel areas R, the blue sub-pixel areas B, and the green sub-pixel areas G in equal proportion, that is, N/3 primary photo spacers 1 are arranged in the red sub-pixel areas R, N/3 primary photo spacers 1 are arranged in the blue sub-pixel areas B, and N/3 primary photo spacers 1 are arranged in the green sub-pixel areas G, and as compared with the primary photo spacers 1 arranged only in sub-pixel areas in one color, the density of the primary photo spacers 1 in sub-pixel areas in each color can be lowered to thereby lower such a risk of the display abnormality such as a transverse line, a longitudinal line, or an oblique line in a monochromatic picture. Furthermore there is a uniform density of the primary photo spacers 1 in the red sub-pixel areas R, the blue sub-pixel areas B, and the green sub-pixel areas G, and as a result, there is a uniform display effect of a monochromatic picture in the corresponding color, thus further improving the display quality of the product, and the experience of a user thereof.

It shall be noted that in the condition that the total number N of arranged primary photo spacers is constant, in the pixel structure according to the fourth embodiment, the primary photo spacers are arranged in sub-pixel areas in three different colors in equal proportion in such a way that N/3 primary photo spacers are arranged respectively in sub-pixel areas in each color. In the pixel structure according to the first, second, and third embodiments, the primary photo spacers are arranged in sub-pixel areas in two different colors in equal proportion in such a way that N/2 primary photo spacers are arranged respectively in sub-pixel areas in each color. Thus the density of the primary photo spacers in sub-pixel areas in each color in the fourth embodiment is lower than the density of the primary photo spacers in sub-pixel areas in each color in the first, second, and third embodiments, that is, the pixel structure according to the fourth embodiment can further lower such a risk of the display abnormality such as a transverse line, a longitudinal line, or an oblique line in a monochromatic picture, and further improve the display quality, and the experience of a user, as compared with the pixel structure according to the first, second, and third embodiments.

It shall be noted that FIG. 3 to FIG. 6 illustrate the positions of the primary photo spacers in the pixel structure, and the arrangement pattern of the RGB sub-pixels only for the purpose of illustrating the pixel structure according to the embodiments of this disclosure, but in a real application, the arrangement pattern of the RGB sub-pixels can be set as needed, and the positions of the primary photo spacers can be set as needed given the arrangement pattern of the RGB sub-pixels, where the primary photo spacers are arranged in sub-pixel areas in at least two colors.

Optionally any one of the sub-pixel areas further includes a black matrix, and a positive projection of the primary photo spacer lies within a positive projection of the black matrix in the direction perpendicular to the pixel structure.

Optionally the photo spacers further include secondary photo spacers, and the area of a positive projection of a black matrix surrounding a primary photo spacer in the direction perpendicular to the pixel structure is larger than the area of a positive projection of a black matrix surrounding a secondary photo spacer in the direction perpendicular to the pixel structure.

It shall be noted that the secondary photo spacers are arranged in the pixel structure in addition to the primary photo spacers. In the case that the photo spacers shall correspond to the sub-pixel areas in a one-to-one manner, the secondary photo spacers can be arranged in the sub-pixel areas where no primary photo spacers are arranged. In the case that the number of photo spacers is constant, the numbers and arrangement patterns of the primary photo spacers and the secondary photo spacers can be set as needed in reality, although the embodiment of this disclosure will not be limited thereto. Furthermore in the pixel structure according to the embodiments of this disclosure, the primary photo spacer are arranged in sub-pixel areas in at least two colors to thereby lower a risk of the display abnormality such as a transverse line, a longitudinal line, or an oblique line in a monochromatic picture, but in order to prevent scratching of an orientation film (for example, PI), which would otherwise have resulted in a press gap, the areas of the black matrixes, surrounding the primary photo spacers, arranged in the sub-pixel areas in whichever of the colors shall be extended, that is, the areas of the projections of the black matrixes surrounding the primary photo spacers should be larger than the areas of the projections of the black matrixes surrounding the secondary photo spacers.

Optionally the secondary photo spacers are arranged in sub-pixel areas in at least two colors in equal proportion. For example, the secondary photo spacers are arranged in sub-pixel areas in any two colors among the sub-pixel areas in the first color, the sub-pixel areas in the second color, and the sub-pixel areas in the third color in equal proportion, or the secondary photo spacers are arranged in the sub-pixel areas in the first color, the sub-pixel areas in the second color, and the sub-pixel areas in the third color in equal proportion. In the pixel structure according to the embodiments of this disclosure, the secondary photo spacers are arranged in the sub-pixel areas in the different colors in equal proportion, so that there is a uniform density of the secondary photo spacers in sub-pixel areas in each color, thus further improving the display effect.

Optionally the pixel structure further includes a color filter substrate on which sub-pixels are located.

An embodiment of this disclosure provides a display panel including the pixel structure according to the embodiment of this disclosure.

For example, the display panel according to the embodiment of this disclosure can be a liquid crystal display panel.

An embodiment of this disclosure provides a display device including the display panel according to the embodiment of this disclosure.

For example, the display device according to the embodiment of this disclosure can be a mobile phone, a TV set, a computer, or another display device.

In summary, in the pixel structure, the display panel, and the display device according to the embodiments of this disclosure, the primary photo spacers are arranged in the sub-pixel areas in at least two colors, that is, the primary photo spacers are arranged in the sub-pixel areas in more than one color, so that in the case that the total number of arranged primary photo spacers is constant, the density of the primary photo spacers in the sub-pixel areas in a single color is lowered, and consequently a risk of the display abnormality such as a transverse line, a longitudinal line, or an oblique line in a monochromatic picture can be lowered. Furthermore in the pixel structure according to the embodiments of this disclosure, the display quality of the product can be improved, and the experience of a user can be improved, while no new fabrication process is introduced, a good yield of the fabricated product is not lowered, and a cost thereof is not increased. Furthermore in the pixel structure according to the embodiments of this disclosure, when the primary photo spacers are arranged in sub-pixel areas in different colors in equal proportion so that there is a uniform density of the primary photo spacers in the sub-pixel areas in each color, and as a result, there is a uniform display effect of a monochromatic picture in the corresponding color, thus further improving the display quality of the product, and the experience of a user thereof.

Evidently those skilled in the art can make various modifications and variations to the application without departing from the spirit and scope of the application. Thus the application is also intended to encompass these modifications and variations thereto so long as the modifications and variations come into the scope of the claims appended to the application and their equivalents.

1. A pixel structure, comprising:
a plurality of sub-pixels in different colors, and
a plurality of photo spacers arranged in sub-pixel areas, wherein the photo spacers comprise primary photo spacers arranged in the sub-pixel areas in at least two of the colors.

2. The pixel structure according to claim 1, wherein the primary photo spacers are arranged in sub-pixel areas in at least two colors in equal proportion.

3. The pixel structure according to claim 1, wherein the sub-pixels in the different colors comprise sub-pixels in a first color, sub-pixels in a second color, and sub-pixels in a third color.

4. The pixel structure according to claim 3, wherein the primary photo spacers are arranged in sub-pixel areas in the first color, sub-pixel areas in the second color, and sub-pixel areas in the third color in equal proportion.

5. The pixel structure according to claim 3, wherein the primary photo spacers are arranged in sub-pixel areas in any two of the colors among sub-pixel areas in the first color, sub-pixel areas in the second color, and sub-pixel areas in the third color, in equal proportion.

6. The pixel structure according to claim 3, wherein the sub-pixels in the first color are red sub-pixels, the sub-pixels in the second color are green sub-pixels, and the sub-pixels in the third color are blue sub-pixels.

7. The pixel structure according to claim 1, wherein each of the sub-pixel areas further comprises a black matrix, and a positive projection of each of the photo spacers in a direction perpendicular to the pixel structure lies within a positive projection of each black matrix in the direction perpendicular to the pixel structure.

8. The pixel structure according to claim 7, wherein the photo spacers further comprise secondary photo spacers, and in the direction perpendicular to the pixel structure, an area of a positive projection of the black matrix surrounding the primary photo spacer is larger than an area of a positive projection of the black matrix surrounding the secondary photo spacer.

9. The pixel structure according to claim 8, wherein the secondary photo spacers are arranged in sub-pixel areas in at least two of the colors in equal proportion.

10. The pixel structure according to claim 1, wherein the pixel structure further comprises a color filter substrate on which the sub-pixels are located.

11. A display panel, comprising the pixel structure according to claim 1.

12. A display device, comprising the display panel according to claim 11.
